(19) United States
(12) Patent Application Publication
(10) Pub. No.: US 2026/0116347 A1
(43) Pub. Date: Apr. 30, 2026

(54) SENSOR ASSEMBLY AND VEHICLE

(71) Applicant: Honda Motor Co., Ltd., Tokyo (JP)

(72) Inventors: Connor Isings, Columbus, OH (US); Timothy J. Rupp, Dublin, OH (US)

(21) Appl. No.: 18/926,798

(22) Filed: Oct. 25, 2024

(51) Int. Cl. B60S 1/56; G01S 7/02; G01S 7/40; G01S 7/481; G01S 7/497

(52) U.S. Cl. CPC B60S 1/56; G01S 7/027; G01S 7/4043; G01S 7/4813; G01S 7/497; G01S 2007/4977

(57) ABSTRACT

A sensor assembly mounted on a body panel of a vehicle comprises a sensor housing defining a chamber therein and a sensor housed inside the chamber and facing a vehicle-forward direction. The sensor assembly further comprises a garnish supported on the body panel and coupled to the sensor housing, such that the chamber is formed between the garnish and the sensor housing. The garnish comprises a first region configured to receive high velocity air from the exterior of the vehicle and a ramp region inclined to the first region and extending from a portion of the first region towards a vehicle-rearward direction away from the sensor. The ramp region is configured to receive a first portion of the high velocity air from the first region, such that the ramp region guides the first portion of the high velocity air towards the vehicle-rearward direction away from and over the sensor.

### BACKGROUND

The disclosed subject matter relates generally to a vehicle. More particularly, the disclosed subject matter relates to a fender and a sensor assembly mounted on a body panel of a vehicle.

Integration of cameras and sensors into vehicles has become increasingly important for safety features, such as, lane departure warning and adaptive cruise control and autonomous driving technology. Currently, these cameras and sensor are often mounted facing rearwardly to the vehicle to limit exposure to dirt, debris, and other environmental contaminants. Therefore, these rear-facing sensors typically do not require additional cleaning systems, such as washer nozzles, to maintain clear visibility. However, this rearward-facing orientation limits the application of forward-facing cameras and sensors as they are more susceptible to dirt and debris accumulation due to their exposure to fast-moving air coming from the front of the vehicle.

To enable forward-facing cameras into the vehicles, conventional solutions rely on washer systems to clean the lens of the camera or sensor. These washer systems typically involve complex and bulky components such as nozzles, tubes, and fluid reservoirs. These systems add cost and complexity to the vehicle design and may be prone to failure. Therefore, there is a need for an effective and reliable provision for mounting and protecting the forward-facing cameras on vehicles, by eliminating the dependency on complex and costly washer systems while ensuring optimal performance in various environmental conditions.

### SUMMARY

In accordance with one embodiment of the present disclosure, a sensor assembly mounted on a body panel of a vehicle is disclosed. The sensor assembly comprises a sensor housing defining a chamber therein. The sensor assembly further comprises a sensor housed inside the chamber and facing a vehicle-forward direction, such that the sensor has a field of view to exterior of the vehicle. The sensor assembly further comprises a garnish supported on the body panel and coupled to the sensor housing, such that the chamber is formed between the garnish and the sensor housing. The garnish comprises a first region configured to receive high velocity air from the exterior of the vehicle. The garnish further comprises a ramp region inclined to the first region and extending from a portion of the first region towards a vehicle-rearward direction away from the sensor. The ramp region is disposed upstream of the sensor and configured to receive a first portion of the high velocity air from the first region, such that the ramp region guides the first portion of the high velocity air towards the vehicle-rearward direction away from and over the sensor. The garnish further comprises a receiving region disposed downstream of the sensor and configured to receive the first portion of the high velocity air from the ramp region. The garnish further comprises a second region configured to receive at least the first portion of the high velocity air from the receiving region. The receiving region is inclined to the second region and extends from a portion of the second region towards the vehicle-forward direction and the sensor.

In accordance with another embodiment of the present disclosure, a fender of a vehicle is disclosed. The fender comprises a sensor assembly. The sensor assembly comprises a sensor housing defining a chamber therein. The sensor assembly further comprises a sensor housed inside the chamber and facing a vehicle-forward direction, such that the sensor has a field of view to exterior of the vehicle. The sensor assembly further comprises a garnish coupled to the sensor housing, such that the chamber is formed between the garnish and the sensor housing. The garnish comprises a first region configured to receive high velocity air from the exterior of the vehicle. The garnish further comprises a ramp region inclined to the first region and extending from a portion of the first region towards a vehicle-rearward direction away from the sensor. The ramp region is disposed upstream of the sensor and configured to receive a first portion of the high velocity air from the first region, such that the ramp region guides the first portion of the high velocity air towards the vehicle-rearward direction away from and over the sensor. The garnish further comprises a receiving region disposed downstream of the sensor and configured to receive the first portion of the high velocity air from the ramp region. The garnish further comprises a second region configured to receive at least the first portion of the high velocity air from the receiving region. The receiving region is inclined to the second region and extends from a portion of the second region towards the vehicle-forward direction and the sensor.

In accordance with yet a further embodiment of the present disclosure, a vehicle is disclosed. The vehicle comprises a body panel and a sensor assembly mounted on the body panel. The sensor assembly comprises a sensor housing defining a chamber therein. The sensor assembly further comprises a sensor housed inside the chamber and facing a vehicle-forward direction, such that the sensor has a field of view to exterior of the vehicle. The sensor assembly further comprises a garnish supported on the body panel and coupled to the sensor housing, such that the chamber is formed between the garnish and the sensor housing. The garnish comprises a first region configured to receive high velocity air from the exterior of the vehicle. The garnish further comprises a ramp region inclined to the first region and extending from a portion of the first region towards a vehicle-rearward direction away from the sensor. The ramp region is disposed upstream of the sensor and configured to receive a first portion of the high velocity air from the first region, such that the ramp region guides the first portion of the high velocity air towards the vehicle-rearward direction away from and over the sensor. The garnish further comprises a receiving region disposed downstream of the sensor and configured to receive the first portion of the high velocity air from the ramp region. The garnish further comprises a second region configured to receive at least the first portion of the high velocity air from the receiving region. The receiving region is inclined to the second region and extends from a portion of the second region towards the vehicle-forward direction and the sensor. The garnish further comprises an intermediate region inclined to and extending from the ramp region towards the sensor. The high velocity air travels from the ramp region to the receiving region bypassing the intermediate region. The intermediate region and the receiving region together define a cavity therebetween, such that the sensor has the field of view through the cavity.

### BRIEF DESCRIPTION OF THE DRAWINGS

Certain embodiments of the present disclosure will be better understood from the following description taken in conjunction with the accompanying drawings in which:

FIG. 1 is a perspective view of a vehicle, in accordance with an embodiment of the present disclosure;

FIG. 2 is a sectional view of a sensor assembly mounted on a body panel of the vehicle along a line B-B shown in FIG. 1, in accordance with an embodiment of the present disclosure;

FIG. 3 is a perspective view of the sensor assembly of FIG. 2, in accordance with an embodiment of the present disclosure; and

FIG. 4 is a perspective view of the sensor assembly of FIG. 2 depicting airflow pattern over the sensor assembly, in accordance with an embodiment of the present disclosure.

### DETAILED DESCRIPTION OF EXEMPLARY EMBODIMENTS

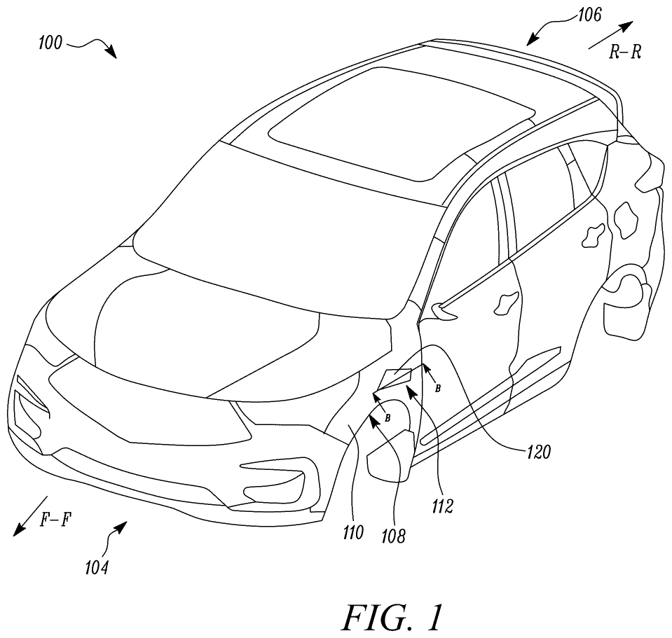

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-4, wherein like numbers indicate the same or corresponding elements throughout the views.

FIG. 1 is a perspective view of a vehicle 100, in accordance with an embodiment of the present disclosure. The vehicle 100 includes a front end 104, a rear end 106, and a body panel 108 extending longitudinally from the front end 104 to the rear end 106. Although the vehicle 100 is shown as a sedan car, it may be appreciated that the vehicle 100 may include any other type of vehicles, such as, but not limited to, hatchback, coupes, sport utility vehicle (SUVs), bus etc.

The body panel 108 further includes at least one fender 110. In some embodiments, the fender 110 is disposed proximate to the front end 104 of the vehicle 100. Alternatively, the fender 110 may be disposed proximate to the rear end 106 of the vehicle 100. In some embodiments, one pair of fenders may be disposed at the front end 104 and another pair of fenders may be disposed at the rear end 106 of the vehicle 100.

The vehicle 100 further includes a sensor assembly 112 mounted on the body panel 108 of the vehicle. In other words, the fender 110 includes the sensor assembly 112. In the illustrated embodiment of FIG. 1, the sensor assembly 112 is mounted on the fender 110 disposed proximate to the front end 104 of the vehicle 100. In some embodiments, the sensor assembly 112 may also be mounted on another fender that is disposed proximate to the rear end 106 of the vehicle 100.

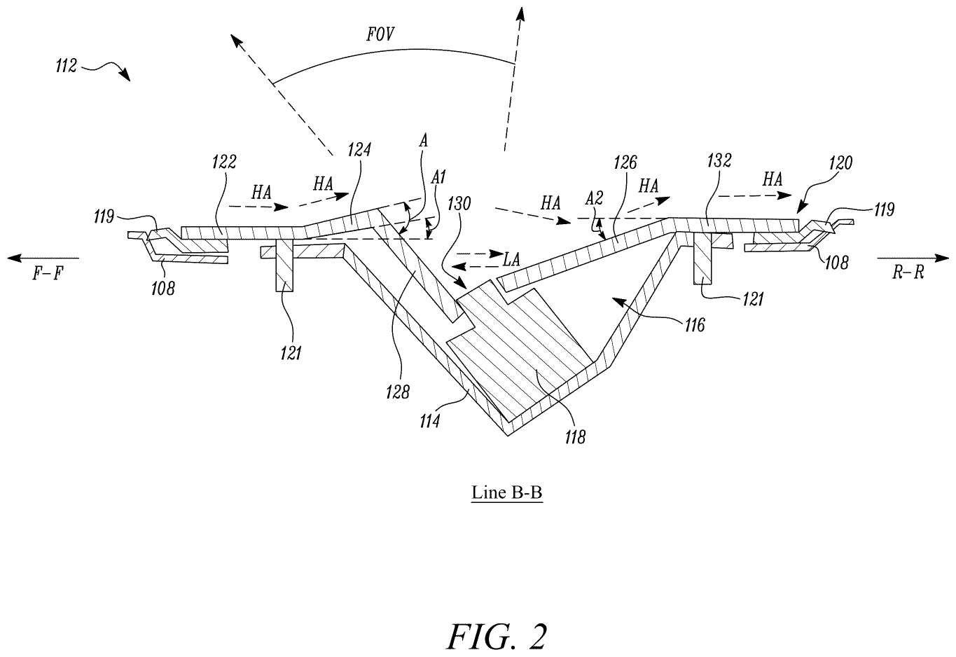

FIG. 2 is a sectional view of the sensor assembly 112 along a line B-B shown in FIG. 1, in accordance with an embodiment of the present disclosure. As shown, the sensor assembly 112 includes a sensor housing 114 defining a chamber 116 therein. The sensor assembly 112 further includes a sensor 118 housed inside the chamber 116 and facing a vehicle-forward direction F-F, such that the sensor 118 has a field of view FOV to exterior of the vehicle 100. In some embodiments, the sensor 118 includes one of an imaging sensor, a LIDAR sensor, and a radar sensor. In some embodiments, the sensor 118 may include one or more cameras facing in the vehicle-forward direction F-F.

The sensor assembly 112 further includes a garnish 120 supported on the body panel 108 and coupled to the sensor housing 114, such that the chamber 116 is formed between the garnish 120 and the sensor housing 114. In the illustrated embodiment of FIG. 2, the garnish 120 is coupled to the sensor housing 114 by using one or more fasteners 121. In some embodiments, the garnish 120 may be coupled to the sensor housing 114 by other means, such as but not limited to, adhesives tapes, welding, riveting, or any other joining techniques. In some embodiments, the sensor assembly 112 further includes a seal 119 disposed between the garnish 120 and the body panel 108. In some embodiments, the garnish 120 is made of a high temperature resistant material such as fiberglass, plastic, polymer, or combination thereof.

The garnish 120 includes a first region 122 configured to receive high velocity air HA from the exterior of the vehicle 100. The garnish 120 is sloped/inclined upwardly relative to the body panel 108 to guide the high velocity air HA in a specific direction. The garnish 120 further includes a ramp region 124 inclined to the first region 122 and extending from a portion of the first region 122 towards a vehicle-rearward direction R-R away from the sensor 118. Accordingly, a first angle A1 is defined between the ramp region 124 and the first region 122. In some embodiments, the first angle A1 between the ramp region 124 and the first region 122 is at most 45 degrees.

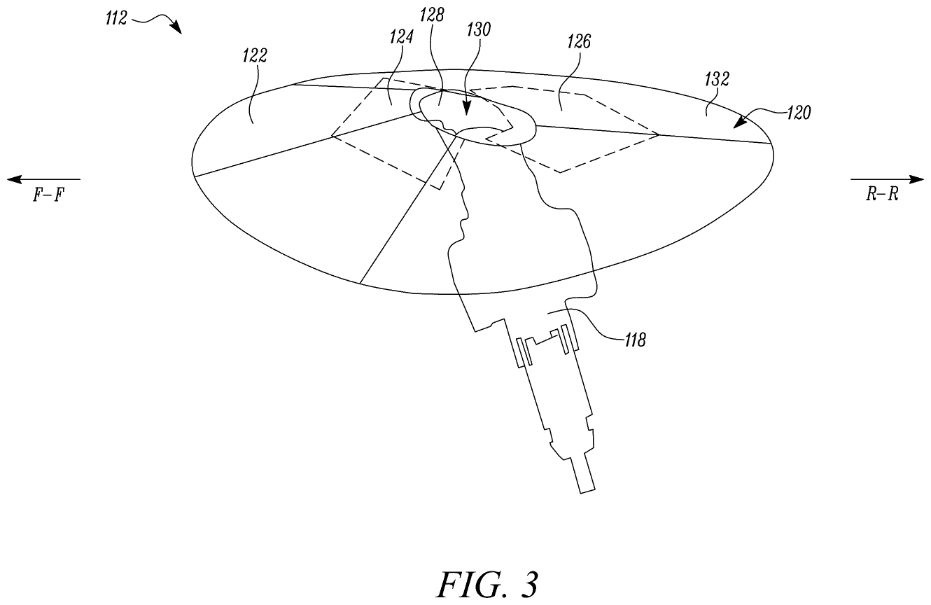

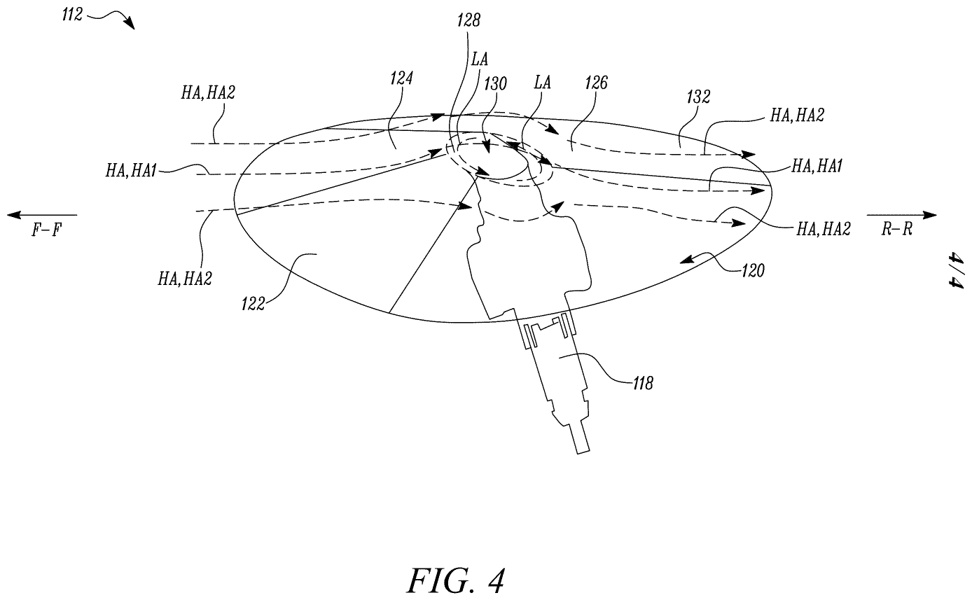

FIG. 3 is a perspective view of the sensor assembly 112, in accordance with an embodiment of the present disclosure. FIG. 4 is a perspective view of the sensor assembly 112 depicting airflow pattern over the sensor assembly 112. As shown in FIGS. 2 to 4, the ramp region 124 is disposed upstream of the sensor 118 and configured to receive a first portion HA1 of the high velocity air HA from the first region 122, such that the ramp region 124 guides the first portion of the high velocity air HA1 towards the vehicle-rearward direction R-R away from and over the sensor 118. The angular inclination of the ramp region 124 relative to the first region 122 guides the first portion HA1 of the high velocity air HA towards the vehicle-rearward direction R-R away from and over the sensor 118.

In some embodiments, the ramp region 124 is also configured to receive a second portion HA2 of the high velocity air HA from the first region 122, such that the ramp region 124 guides the second portion HA2 of the high velocity air HA towards the vehicle-rearward direction R-R away from and around the sensor 118.

The garnish 120 further includes a receiving region 126 disposed downstream of the sensor 118 and configured to receive the first portion HA1 of the high velocity air HA from the ramp region 124. Additionally, the garnish 120 includes an intermediate region 128 inclined to and extending from the ramp region 124 towards the sensor 118. The high velocity air HA travels from the ramp region 124 to the receiving region 126 bypassing the intermediate region 128. The receiving region 126 is optimized to ensure the airflow reattached smoothly to the garnish 120 and the vehicle 100, thereby preventing premature air separation. By preventing the premature air separation, the aerodynamics of the vehicle 100 is improved, which further improves the fuel economy.

In some embodiments, an angle A between the intermediate region 128 and the ramp region 124 is at least 30 degrees. In the illustrated embodiment of FIG. 2, the angle A between the intermediate region 128 and the ramp region 124 is 45 degrees. Further, the intermediate region 128 and the receiving region 126 together define a cavity 130 therebetween, such that the sensor 118 has the field of view FOV through the cavity 130.

As shown in FIG. 2, upon movement of the vehicle 100, the ramp region 124 causes low velocity air LA to flow in vicinity of the cavity 130, thereby guiding the high velocity air HA towards the vehicle-rearward direction R-R away from and over the sensor 118. In other words, the ramp region 124 creates a high-pressure zone of low velocity air LA over the sensor 118 which effectively protects the sensor 118 from the dirt and debris carried by the high velocity air HA. This ensures that the forward-facing sensor 118 (i.e., lens of the camera) remains clear and operational in varying environmental conditions, such as dirt or road debris, thereby enhancing reliability and performance of the sensor 118.

Furthermore, the garnish 120 includes a second region 132 configured to receive at least the first portion HA1 of the high velocity air HA from the receiving region 126. The receiving region 126 is inclined to the second region 132 and extends from a portion of the second region 132 towards the vehicle-forward direction F-F and the sensor 118. The second portion HA2 of the high velocity air HA travels from the first region 122 to the second region 132 by traversing around the sensor 118.

In some embodiments, the first region 122 and the second region 132 are integral with each other. In some embodiments, the first region 122, the ramp region 124, the receiving region 126, and the second region 132 are integral with one another, such that the garnish 120 is a one-piece construction. In some embodiments, the first region 122, the ramp region 124, the receiving region 126, the second region 132, and the intermediate region 128 are integral with one another, such that the garnish 120 is a one-piece construction.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A sensor assembly mounted on a body panel of a vehicle, the sensor assembly comprising:
a sensor housing defining a chamber therein;
a sensor housed inside the chamber and facing a vehicle-forward direction, such that the sensor has a field of view to exterior of the vehicle; and
a garnish supported on the body panel and coupled to the sensor housing, such that the chamber is formed between the garnish and the sensor housing, the garnish comprising:
a first region configured to receive high velocity air from the exterior of the vehicle;
a ramp region inclined to the first region and extending from a portion of the first region towards a vehicle-rearward direction away from the sensor, wherein the ramp region is disposed upstream of the sensor and configured to receive a first portion of the high velocity air from the first region, such that the ramp region guides the first portion of the high velocity air towards the vehicle-rearward direction away from and over the sensor;
a receiving region disposed downstream of the sensor and configured to receive the first portion of the high velocity air from the ramp region; and
a second region configured to receive at least the first portion of the high velocity air from the receiving region, wherein the receiving region is inclined to the second region and extends from a portion of the second region towards the vehicle-forward direction and the sensor.

2. The sensor assembly of claim 1, further comprising an intermediate region inclined to and extending from the ramp region towards the sensor, wherein the high velocity air travels from the ramp region to the receiving region bypassing the intermediate region.

3. The sensor assembly of claim 2, wherein an angle between the intermediate region and the ramp region is at least 30 degrees.

4. The sensor assembly of claim 2, wherein the intermediate region and the receiving region together define a cavity therebetween, such that the sensor has the field of view through the cavity.

5. The sensor assembly of claim 4, wherein, upon movement of the vehicle, the ramp region causes low velocity air to flow in vicinity of the cavity, thereby guiding the high velocity air towards the vehicle-rearward direction away from and over the sensor.

6. The sensor assembly of claim 1, wherein the first region and the second region are integral with each other.

7. The sensor assembly of claim 1, wherein the first region, the ramp region, the receiving region, and the second region are integral with one another, such that the garnish is a one-piece construction.

8. The sensor assembly of claim 1, wherein the ramp region is further configured to receive a second portion of the high velocity air from the first region, such that the ramp region guides the second portion of the high velocity air towards the vehicle-rearward direction away from and around the sensor, and wherein the second portion of the high velocity air travels from the first region to the second region by traversing around the sensor.

9. The sensor assembly of claim 1, further comprising a seal disposed between the garnish and the body panel.

10. The sensor assembly of claim 1, wherein the sensor comprises one of an imaging sensor, a LIDAR sensor, and a radar sensor.

11. The sensor assembly of claim 1, wherein the garnish is coupled to the sensor housing by using one or more fasteners.

12. The sensor assembly of claim 1, wherein the garnish is made of a high temperature resistant material such as fiberglass, plastic, polymer, or combination thereof.

13. The sensor assembly of claim 1, wherein a first angle between the ramp region and the first region is at most 45 degrees.

14. The sensor assembly of claim 1, wherein a second angle between the receiving region and the second region is at most 60 degrees.

15. A fender of a vehicle, the fender comprising:
a sensor assembly comprising:
a sensor housing defining a chamber therein;
a sensor housed inside the chamber and facing a vehicle-forward direction, such that the sensor has a field of view to exterior of the vehicle; and
a garnish coupled to the sensor housing, such that the chamber is formed between the garnish and the sensor housing, the garnish comprising:
a first region configured to receive high velocity air from the exterior of the vehicle;
a ramp region inclined to the first region and extending from a portion of the first region towards a vehicle-rearward direction away from the sensor, wherein the ramp region is disposed upstream of the sensor and configured to receive a first portion of the high velocity air from the first region, such that the ramp region guides the first portion of the high velocity air towards the vehicle-rearward direction away from and over the sensor;
a receiving region disposed downstream of the sensor and configured to receive the first portion of the high velocity air from the ramp region; and
a second region configured to receive at least the first portion of the high velocity air from the receiving region, wherein the receiving region is inclined to the second region and extends from a portion of the second region towards the vehicle-forward direction and the sensor.

16. The fender of claim 15, wherein the sensor assembly further comprises an intermediate region inclined to and extending from the ramp region towards the sensor, wherein the high velocity air travels from the ramp region to the receiving region bypassing the intermediate region.

17. The fender of claim 16, wherein the intermediate region and the receiving region together define a cavity therebetween, such that the sensor has the field of view through the cavity.

18. The fender of claim 15, wherein the first region, the ramp region, the receiving region, and the second region are integral with one another, such that the garnish is a one-piece construction.

19. A vehicle comprising:
a body panel; and
a sensor assembly mounted on the body panel, the sensor assembly comprising:
a sensor housing defining a chamber therein;
a sensor housed inside the chamber and facing a vehicle-forward direction, such that the sensor has a field of view to exterior of the vehicle; and
a garnish supported on the body panel and coupled to the sensor housing, such that the chamber is formed between the garnish and the sensor housing, the garnish comprising:
a first region configured to receive high velocity air from the exterior of the vehicle;
a ramp region inclined to the first region and extending from a portion of the first region towards a vehicle-rearward direction away from the sensor, wherein the ramp region is disposed upstream of the sensor and configured to receive a first portion of the high velocity air from the first region, such that the ramp region guides the first portion of the high velocity air towards the vehicle-rearward direction away from and over the sensor;
a receiving region disposed downstream of the sensor and configured to receive the first portion of the high velocity air from the ramp region;
a second region configured to receive at least the first portion of the high velocity air from the receiving region, wherein the receiving region is inclined to the second region and extends from a portion of the second region towards the vehicle-forward direction and the sensor; and
an intermediate region inclined to and extending from the ramp region towards the sensor, wherein the high velocity air travels from the ramp region to the receiving region bypassing the intermediate region, and wherein the intermediate region and the receiving region together define a cavity therebetween, such that the sensor has the field of view through the cavity.

20. The vehicle of claim 19, wherein the first region, the ramp region, the receiving region, the second region, and the intermediate region are integral with one another, such that the garnish is a one-piece construction.
